(19) United States
(12) Patent Application Publication
(10) Pub. No.: US 2003/0078978 A1
(43) Pub. Date: Apr. 24, 2003

(54) Firmware portable messaging units utilizing proximate communications

(76) Inventors: Clifford Lardin, Ithaca, NY (US); David Holbrook, Lexington, MA (US); Terence Sean Sullivan, Brookline, MA (US)

Correspondence Address: Terence Sean Sullivan, P.O. Box 425475, Cambridge, MA, 02142, US

(21) Appl. No.: 10/001,550

(22) Filed: Oct. 23, 2001

(51) Int. Cl. G06F 15/16

(52) U.S. Cl. 709/206

(57) ABSTRACT

A method and apparatus for a messaging system (10) comprising a plurality of messaging nodes (14) at geographically distributed and publicly accessible locations, and a plurality of firmware-controlled portable messaging units (16) configured to specific user accounts and including message composition, display and storage means. Communication between these portable messaging units (16) and the messaging system, including messaging with Internet addresses, requires that a portable messaging unit (40) be brought to the immediate physical proximity of a messaging node (20), so that a data exchange (90) may be conducted using simple communications equipment such as an infrared link. Messaging nodes (14) preferably include a plurality of docking ports (26) for conducting data exchanges (90) simultaneously with multiple portable messaging units (16). The messaging system includes multiple layers of parallelization, including the separation of user interface activity from the messaging nodes (14), and the inclusion of multiple docking ports (26) on each messaging node (20).

### FIELD OF THE INVENTION

This invention relates to messaging systems, specifically to an improved method for operating portable messaging units controlled by firmware and utilizing proximate communications with messaging nodes.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

In conventional messaging systems employing portable messaging units, the portable messaging units include sophisticated communications equipment. In some systems, such as pagers and wireless e-mail systems, this equipment may comprise medium-distance or long-distance wireless radio frequency receivers or transceivers utilizing highly reliable and virtually continuous communications channels with one or more messaging nodes. In other systems, such as laptop computers and Palm Pilot devices, this equipment may comprise communications means for managing an Internet TCP/IP format data transfer, often with associated means for initiating a communications exchange over telephony lines. In another configuration, such as a Palm Pilot/desktop computer synchronization of e-mail folders, participation in a messaging system requires that data pass through a single messaging node configured as the desktop mirror for an individual Palm Pilot. In other systems, such as inventory management devices at retail stores, this equipment is not part of a messaging system that may be used to interchange messages with similar portable messaging units utilizing other messaging nodes, or with external networks such as the Internet. The inclusion of sophisticated communications means in portable messaging units imposes an undesirable expense.

In conventional messaging systems permitting remote access by proximate physical access to a plurality of geographically dispersed, publicly available messaging nodes, such as Internet cafes, the factor limiting computer throughput efficiency is user interface activity at the computer terminals provided at said messaging nodes. For example, in a computer configured for e-mail access, the limiting factor is user interface time for reading and writing messages. The computer's other functions, such as communicating with an e-mail server, consume a relatively minor amount of time. The requirement that the messaging node provide the user interface functions for a messaging system imposes an undesirable inefficiency in such messaging nodes.

In many conventional systems employing portable messaging units, a communications channel is continuously available with a messaging node. Communications dropouts, when they occur, are unplanned and typically have adverse effects on system users. While data may not be continuously exchanged between a portable messaging unit and a messaging node, the channel maintains coherence as the portable unit is taken throughout a wide geographic region, and the channel is continuously monitored by at least one of the participating devices. Examples include regional radio frequency communications systems, such as are used by pagers, wireless e-mail systems and cellular telephones. Ensuring the continuous availability of a communications channel imposes significant constraints on the infrastructural requirements of the messaging nodes, and the communications sophistication of the portable messaging units. Such systems commonly use complex radio frequency equipment of sufficient power to require special licenses allocating the exclusive use of a section of broadcast spectrum, imposing undesirable costs and licensing constraints on the messaging system.

Known methods for transferring data between a host device and a plurality of portable computers, such as U.S. Pat. Nos. 5,621,980 and 5,301,346 to Notarianni, et al, are applicable to pen-based computers such as a Palm Pilot, and make no provision for a plurality of messaging nodes or the interconnection dynamics of the messaging node with a network. A geographic based communications service, described in U.S. Pat. No. 6,259,405 to Brett, et al, provides messages to users in response to their physical location and demographic characteristics, but the method is not useful for person-to-person messages, and presumes a wireless network with a wide coverage area. A method for a geographic-based communications service, described in U.S. Pat. No. 5,969,678 to Stewart, depends upon real-time communications with a central server or message source, and provides location-dependent content. A method and apparatus for computed relevance messaging, described in U.S. Pat. No. 6,256,664 to Donoho, et al, provides for the delivery of a subset of all possible automated messages to a user, but does not dynamically determine message selection to accomodate a network resource limitation. A method for checking the access rights of subscriber equipment, described in U.S. Pat. No. 6,091,946 to Ahvenainen, provides for the verification of the account status of a portable messaging unit, but depends upon a stable association between physical equipment and specific user accounts. A method for conducting internet searches from a portable computer, described in U.S. Pat. No. 5,978,833 to Pashley, et al, depends upon on-demand communications being available between the portable computer and the network serving as a repository of the search target data.

### SUMMARY OF THE INVENTION

In accordance with the present invention, a messaging system comprises a plurality of messaging nodes at geographically distributed and publicly accessible locations, and a plurality of portable messaging units configured to specific user accounts, where said portable messaging units are firmware-controlled messaging devices providing message composition, display and storage means. Communication between these portable messaging units and the messaging system (including messaging with Internet addresses) requires that a portable messaging unit be brought to the immediate physical proximity of a messaging node, so that a data exchange may be conducted using simple communications equipment such as an infrared link.

To maximize messaging node throughput, it may be desirable to enable a plurality of users to simultaneously perform user interface functions, even if other computer functions are not parallelized. Thus, it is advantageous to split the user interface activity from other computer functions, such as operating a TCP/IP stack and having access to external communications means. A truly basic user interface for a messaging system places sophisticated communications means on dedicated messaging nodes capable of serving a large user base, and places user interface functions on portable messaging units with only minimal communications means sufficient for data exchanges in the immediate proximity of these messaging nodes. By accepting the lack of a continuously available communications channel, including telephony or wireless access to a remote messaging node, the complexity of portable messaging units is significantly reduced in comparison to prior art messaging systems. Combined with the use of firmware for controlling a dedicated portable messaging unit, the present invention provides means for a messaging system employing very low-cost portable messaging units.

In one aspect, the present invention comprises a messaging system with a plurality of messaging nodes, a plurality of user accounts with distinct messaging address identifiers, and a plurality of portable messaging units including a) storage means for firmware for controlling messaging operations;

b) storage means for the storage of messages;

c) composition means for the composition of messages;

d) display means for the display of messages;

e) associative means for associating at least one of said portable messaging units with at least one of said user accounts, and

f) communications means for conducting a data exchange with a messaging node, when in an immediate proximity of said messaging node;

whereby a plurality of said portable messaging units may conduct two-way messaging via said messaging system when in said immediate proximity to at least one messaging node of said messaging system, and conduct user interface functions irrespective of location.

Further aspects of the present invention are described in the detailed description and alternative embodiments that follow.

Accordingly, several objects and advantages of the present invention are:

a) to enable access to a messaging system from a plurality of geographically distributed messaging nodes, using low-cost firmware-based portable messaging units without sophisticated communications equipment;

b) to separate user interface activity from an expensive messaging node computer, and relocate such user interface activity to a low-cost dedicated firmware portable messaging unit;

c) to allow multiple users to simultaneously conduct user interface activities on personal user interface devices, in conjunction with the usage of a single messaging node for the communication of data in a messaging system;

d) to amortize the costs of owning and operating a messaging node across a large number of messaging system users, who engage in brief data exchanges with said messaging node as a gateway to the outside world, but otherwise conduct user interface functions on low-cost personal portable messaging units;

e) to allow a user to conduct user interface activity on a low-cost portable messaging unit, while this device is not in contact with other elements of a messaging system;

f) to enable the collection of incoming messages from a messaging node, without active on-demand communications with a central server responsible for the distribution of said incoming messages, and

g) to allow a user to learn a user interface for a messaging system without consuming resources on a relatively expensive messaging node computer.

Further objects and advantages will become apparent from a consideration of the drawings and ensuing description.

### BRIEF DESCRIPTION OF THE DRAWINGS

FIG. 1 Block diagram of messaging system 10

FIG. 2 Block diagram of messaging node 20

FIG. 3 Illustration of portable messaging unit 40

FIG. 4 Block diagram of portable messaging unit 40

FIG. 5 Illustration of association table 80

FIG. 6 Flowchart of data exchange 90

### REFERENCE NUMERALS IN THE DRAWINGS

10 Messaging system

12 Central server

14 Messaging nodes

16 Portable messaging units

20 Messaging node

22 Node computer

24 Distribution interface

26 Docking ports

28 Second CPU

30 First infrared transceiver

32 Status light

34 Display monitor

36 Home button

40 Portable messaging unit

42 User input device

44 User output device

46 Battery

48 Second infrared transceiver

50 First CPU

52 Non-Volatile memory

54 ROM

56 Speaker

58 Power button

60 Inbox button

61 Archive button

62 Outbox button

63 Hold/Save button

64 Reply button

65 Delete button

66 Address button

67 Menu button

68 Sequence buttons

69 Scroll buttons

70 First communications link

72 Second communications link

74 Third communications link

80 Association table

82 Primary messaging zone

84 Secondary messaging zone

86 Foreign messaging node

88 User account

90 Data exchange

91 Detection of placement of portable messaging unit

92 Account Verification

93 Transfer of outgoing messages

94 PMU 40 reports amount of free memory

95 Prioritization of data

96 Transfer of selected messages

97 Transaction completion

### DETAILED DESCRIPTION OF THE INVENTION

The present invention provides methods and apparatus for operating portable messaging units controlled by firmware that utilize proximate communications with messaging nodes.

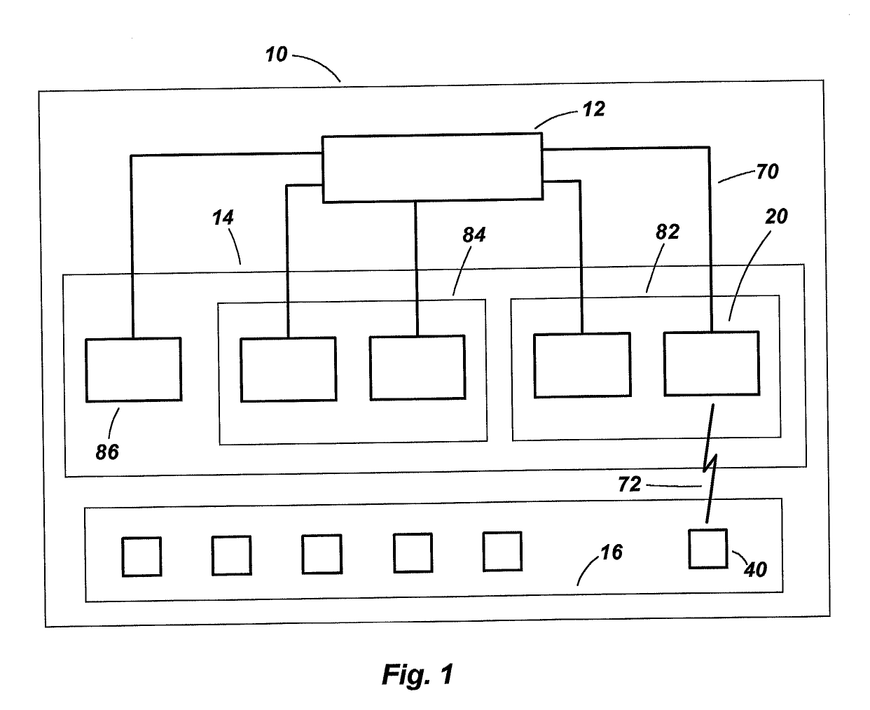

FIG. 1 shows a block diagram of a messaging system apparatus, according to a preferred embodiment of the invention. In this embodiment, messaging system 10 comprises a central server 12, a plurality of messaging nodes 14, and a plurality of portable messaging units 16.

Messaging nodes 14 comprise a plurality of instances of messaging node 20, distributed in publicly accessible locations across a geographic region. Each messaging node 20 has access, either continuously or intermittently, to a first communications link 70 with central server 12. First communications link 70 may comprise a dial-up modem connection over telephony lines (either direct point-to-point or via ISP Internet services), Cable/Modem connection, DSL, satellite link (including full-duplex connections using geosynchronous, medium Earth orbit, or Molniya orbit spacecraft; or ‘store-and-forward’ services from spacecraft in low Earth orbit), radio frequency transceiver link, local area network, or other similar data exchange means known to persons skilled in the art. Individual members of messaging nodes 14 may utilize different data exchange means for first communications link 70 to central server 12.

Portable messaging units 16 are usually disconnected from all other elements of messaging system 10, except when a user brings an individual portable messaging unit 40 to an individual messaging node 20, at which time temporary second communications link 72 may be established between portable messaging unit 40 and messaging node 20. Portable messaging unit 40 and messaging node 20 are arbitrary members of portable messaging units 16 and messaging nodes 14, respectively; any portable messaging unit may be connected at any messaging node. Individual users of messaging system 10 have user accounts, which may be associated with one or more distinct messaging address identifiers, such as e-mail addresses. An instance of portable messaging unit 40 may be configured for operation with one or more user accounts.

Messaging Node

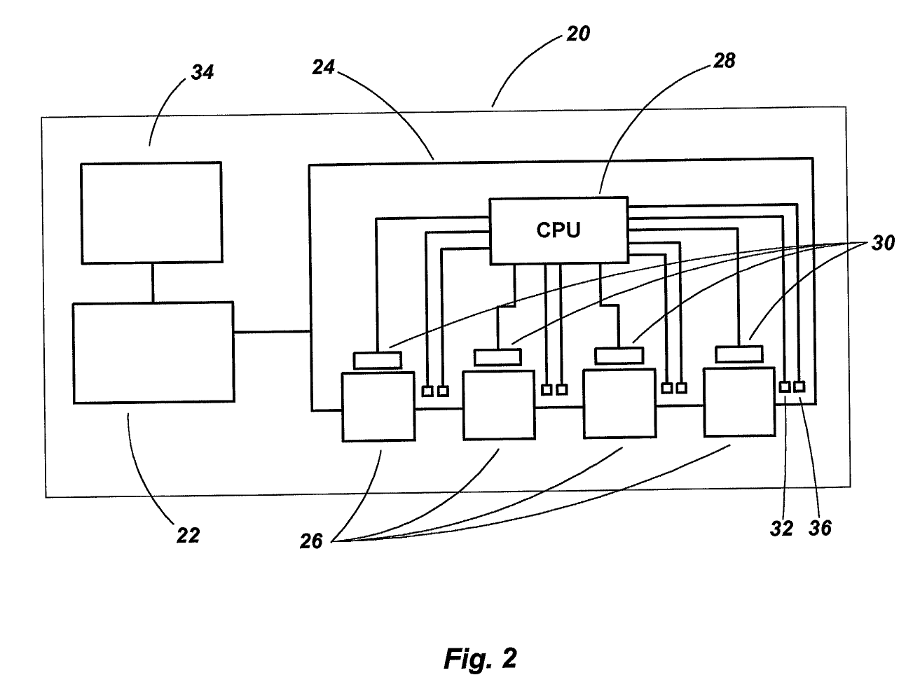

FIG. 2 shows a block diagram of an arbitrary messaging node 20, representative of the members of messaging nodes 14. Messaging node 20 serves as a message distribution node for providing messages to a plurality of users, and includes a node computer 22, a distribution interface 24 providing a plurality of docking ports 26, and an optional display monitor 34.

Node computer 22 includes a serial input/output port for conducting communications with distribution interface 24, non-volatile storage means for the storage of executable program code and data messages, a central processing unit (CPU), random access memory, communications apparatus appropriate to the data exchange means of first communications link 70, and other standard computing means. Node computer controls optional display monitor 34.

Distribution interface 24 includes a second CPU 28 and plurality of docking ports 26, where each docking port includes a first infrared transceiver 30 including an infrared data transmitter and an infrared data receiver, a status light 32, a home button 36, and a physical seating for a portable messaging unit 40.

Alternative messaging node configurations may be employed. For example, node computer 22 may additionally perform the functions of second CPU 28, although this is not preferred because a dedicated microprocessor may have more input/output lines available for operating a large number of docking ports 26.

Portable Messaging Unit

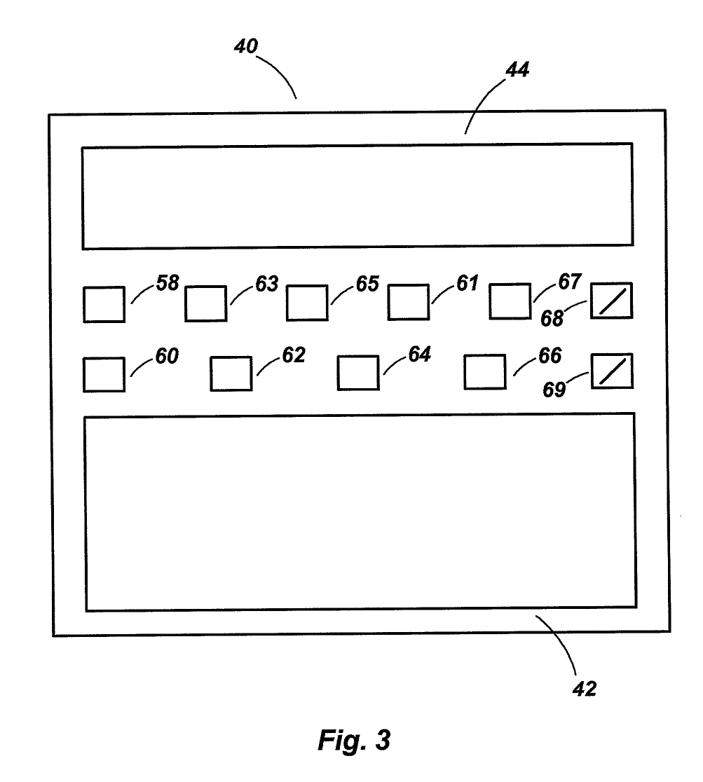

FIG. 3 shows an illustration of portable messaging unit 40, including a user input device 42 which may be a keyboard or keypad device with appropriate keys for alphabetic, numeric, punctuation and text formatting operations, or alternatively a pen-based touch-sensitive pad; a user output device 44 (such as a liquid crystal display), preferably capable of showing at least three lines of text, and at least one intermediate shade of gray in addition to black and white; a series of special function buttons, including an inbox button 60, an archive button 61, an outbox button 62, a hold/save button 63, a reply button 64, a delete button 65, an address button 66, a menu button 67, and a power button 58; a left/right pair of sequence buttons 68; and an up/down pair of scroll buttons 69.

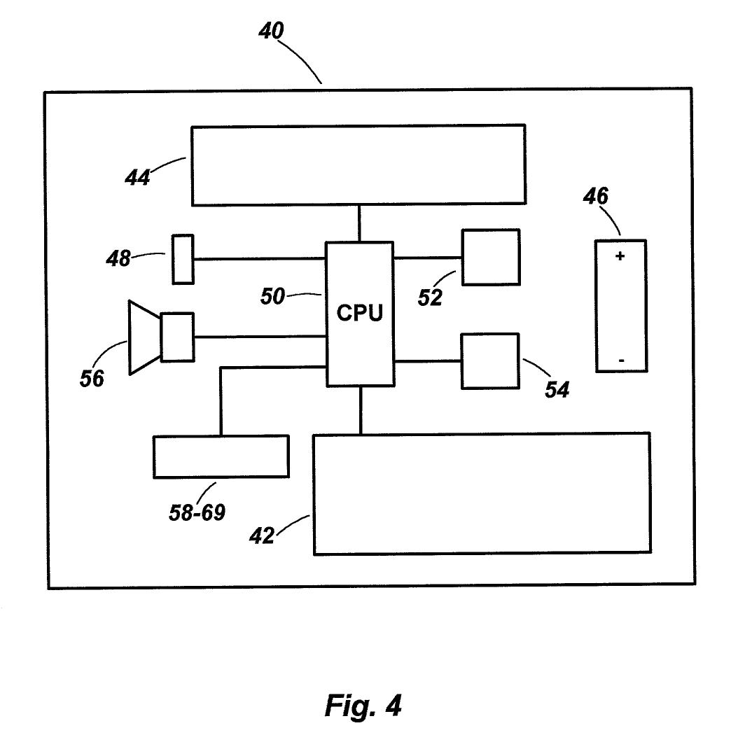

FIG. 4 shows a block diagram of portable messaging unit 40. User input device 42 is connected as an input to first CPU 50, such that first CPU 50 may detect and distinguish keypresses. As an output, first CPU 50 controls user output device 44. If optional speaker 56 is included, speaker 56 is also an output device controlled by first CPU 50. Second infrared transceiver 48, including an infrared data transmitter and infrared data receiver, is connected to first CPU 50 as an input/output device. Battery 46 provides power, and may comprise two single-use or rechargeable AA batteries, coin cells, or solar cells. Portable messaging unit 40 may include a provision for connecting to standard A/C electrical power, and rechargeable batteries may be removed for external charging.

First CPU 50 may be, in a non-limiting example, an application specific integrated circuit (ASIC). First CPU 50 executes a firmware program stored in read-only memory (ROM 54), and stores and retrieves data from random access non-volatile memory 52. An ASIC may also include non-volatile memory 52 and ROM 54 as on-chip elements, or they may be implemented with external devices. First CPU 50 may also be a PIC16F873 available commercially from Microchip Technology of Chandler, Ariz., with certain input/output functions such as driving the LCD display moved to an external accessory chip.

Central Server

In the preferred embodiment, central server 12 comprises a computer with multiprocessor architecture, multiple RAID hard drives providing hundreds of gigabytes of storage capacity, high bandwidth communications means supporting a high speed Internet connection, and running an operating system such as Linux. Such a configuration may support up to approximately 100,000 users. Central server 12 may also comprise a constellation of interrelated computers providing the indicated functions, where said functions are divided among individual computer units with more narrow responsibilities. There may also be a multilevel network architecture between central server 12 and messaging nodes 14, depending on system requirements.

Operation of the Invention

The present invention may be used in messaging system 10 to exchange messages between a plurality of messaging nodes 14 and a plurality of firmware-based portable messaging units 16, thereby enabling portable access to messaging system 10 with simple portable messaging units 16. Specifically, numerous users may compose and read messages on personal low-cost portable messaging units 16. These units have extremely simple communications systems, and must be brought physically to one of the numerous messaging nodes 14 to access the network. These nodes may be geographically distributed in public places, in a manner similar to payphones.

The preferred embodiment comprises a messaging system 10 employing this invention, although other embodiments will be evident to a person of ordinary skill in the art.

Messaging system 10 may be used for the communication of messages between users of messaging system 10, or between such users and persons on external networks such as the Internet. These messages may be plain text, enhanced text formats such as HTML, graphical files, sound files, or other similar formats. Messaging system 10 may fill a wide variety of functions, including as non-limiting examples a publicly available messaging network operated for commercial or non-profit purposes, or a private network providing services to a limited user base such as employees of a specific store or chain of stores. Messaging nodes 14 may be located at public facilities such as post offices, government centers, schools, libaries, parks, urban intersections, train stations, shopping centers, apartment complexes, Internet cafes, stores or chains of stores.

Portable messaging unit 40 is a remote and portable user interface for messaging system 10. Central server 12 is a central repository of data, messages and administrative functions within messaging system 10. Messaging node 20 is a local communications interface for exchanging information between central server 12 and portable messaging unit 40. It is expected that communications link 70 between central server 12 and messaging node 20, and additionally communications link 72 between messaging node 20 and portable messaging unit 40, may be an unreliable or intermittent data connection. The operation of messaging system 10 is designed to provide robust performance under such conditions.

To communicate, portable messaging unit 40 must be brought to the immediate proximity of messaging node 20. By ‘immediate proximity’ it is expected that these devices be within a short-range line of sight (excluding long-range line of sight, as with radio towers), consistent with typical applications employing infrared or ultrasonic communications means. In ordinary circumstances, reasonable proximity includes communications across a room or public gathering area such as a train station platform, within a passageway, or similar distances about an outdoor kiosk messaging node facility. In the preferred embodiment, portable messaging unit 40 is placed in a docking port 26 element of messaging node 20, allowing good optical transmittance for photonic communications between infrared transceivers in each device.

Communications Architecture

Unlike conventional network designs, messaging system 10 treats incoming and outgoing messages differently. To provide reliable communications in a network environment where network connections may not be available upon demand, messaging system 10 proactively buffers incoming messages at messaging nodes selected from messaging nodes 14 where a user may be expected to request the collection of incoming messages. This requires foresight on the part of central server 12, to ensure that messages are delivered proactively during communications sessions with selected members of messaging nodes 14. In contrast, the delivery of outgoing messages does not require similar foresight on the part of messaging system 10. This asymmetry leads to a significantly different treatment of incoming and outgoing messages.

Messaging nodes 14 serve as two-way message distribution nodes, where each node serves a plurality of users. To use messaging system 10, a user must bring a portable messaging unit 40 to a messaging node 20 member of messaging nodes 14, and use the services of messaging node 20 to receive and/or transmit messages. This process is automatically executed upon the placement of portable messaging unit 40 in one of the docking ports 26, and the user receives notification when the process is complete via status light 32. The user may then remove portable messaging unit 40 from messaging node 20, and use portable message device 40 remotely for reading newly received messages, and for writing messages which will be buffered in portable messaging unit 40 until the next visit to a member of messaging nodes 14.

Messaging node 20 establishes occasional communications with central server 12, and thereby participates in the full messaging system 10. Via first communications link 70, and probably other intermediate network elements known to persons skilled in the art, node computer 22 establishes an Internet connection to central server 12 and exchanges various data, such as message traffic and administrative information, as discussed below. Such exchanges may occur on a regular schedule, at regular intervals, at a message volume threshold, or by user request. For example, it may be desirable to initiate a communications session only when message transfer time is significantly longer than the expected time for establishing communications (such as handshaking and similar transactions), to increase the efficiency of connection time. Most preferably, any of several triggers may be responsible for initiating a communications session, such as a large volume of outgoing messages, a time interval sufficiently long for a large volume of incoming messages to be expected, or for a further delay in messaging to have an adverse impact upon the performance of messaging system 10.

The network communication events between messaging node 20 and central server 12 may be intermittent and unreliable, and messaging system 10 is robust in environments where reliable network communications cannot be assured. The system imposes no strict schedule concerning the frequency or timing of data exchange between central server 12 and any individual messaging node 20. Messaging node 20 does not need to maintain an accurate clock, or be assured continuous or regular access to an operational first communications link 70. Message traffic between elements of messaging system 10 may be encrypted to provide security and privacy.

Outgoing Messages

Users of messaging system 10 may generate messages on portable messaging unit 40, a small and inexpensive hand-held device that acts as a portable user interface for messaging system 10. New messages are initially stored on portable messaging unit 40, until the user physically brings this device to messaging node 20, which acts as a local distribution node in messaging system 10.

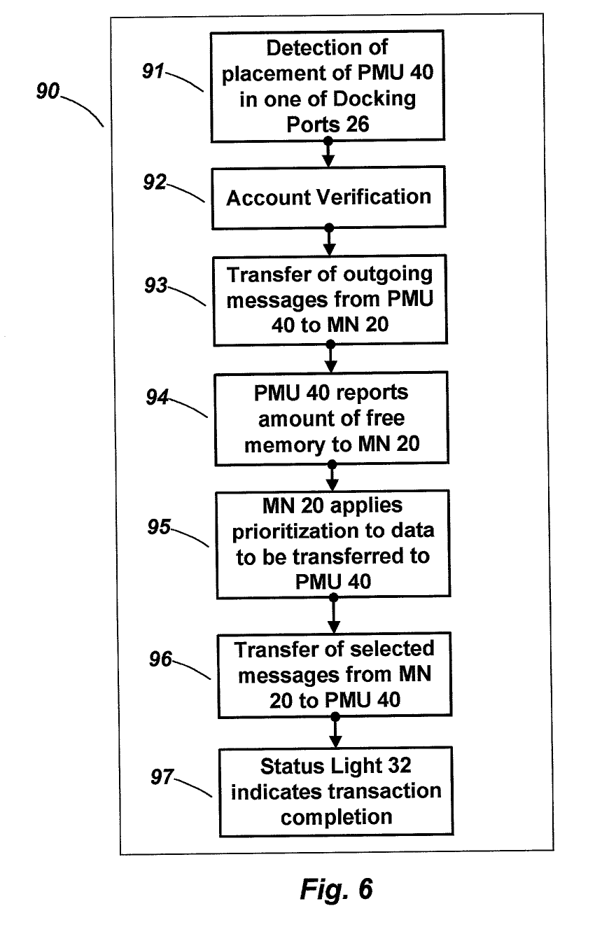

Messaging node 20 provides local message distribution services for a geographic region, and may be located at Internet cafes, high-traffic locations such as airports or train stations, convenience or grocery stores, pedestrian kiosks on urban streets, etc. A user may send outgoing messages from any of messaging nodes 14 within messaging system 10. Each messaging node 20 member of messaging nodes 14 can simultaneously service multiple users. The design of messaging node 20 facilitates a large throughput of users, who may quickly exchange data via docking ports 26 and vacate messaging node 20, making room for additional users. FIG. 6 shows a flowchart of data exchange 90 between portable messaging unit 40 and messaging node 20.

Messaging node 20 has at least occasional communications with a central server 12 over first communications link 70. Some instances of messaging node 20 may have dedicated or continuous network communications, such as Internet DSL or cable/modem service, but such high-quality service is not required. In the preferred embodiment, messaging system 10 is designed for robust operation in an unreliable network environment, and may be employed in circumstances where many messaging node 20 locations are frequently unable to connect, or elect not to connect, to central server 12. This enhances performance in applications where a phone line is shared between data and voice functions, in disaster relief environments where the communications infrastructure has been damaged, and in geographic regions with unreliable electrical grids or public services.

Central server 12 is a central clearinghouse for messages, and administrative agent for managing messaging system 10. Central server 12 also serves as an interface to the Internet, for the delivery of messages to/from addresses outside messaging system 10, if network administration chooses to allow such a gateway service.

If delivery confirmation is requested, the collection of an outgoing message by another user of messaging system 10 may trigger the automatic generation of a confirmation message addressed to the original sender. In an optional variant, portable messaging unit 40 may automatically request such a delivery confirmation, and retain a copy of the outgoing message until this delivery confirmation message is received.

Incoming Messages

Incoming messages are distributed from central server 12, which is responsible for routing and network administrative functions.

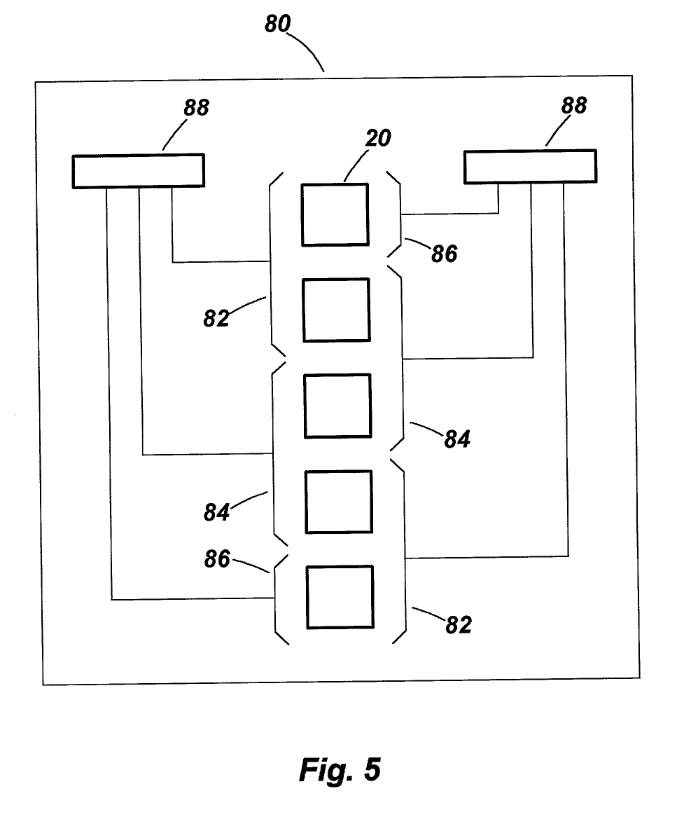

FIG. 5 illustrates an association table 80 database maintained by central server 12, associating each user account 88 with a primary messaging zone 82, comprising a subset of messaging nodes 14. (The use of the word ‘subset’ herein has the mathematical meaning, inclusive of the option of a subset A of set B where A=B). Primary messaging zone 82 is important for maintaining robust performance in an unreliable or intermittent network environment because an arbitrary messaging node 20 may be unable to (or, for reason's such as cost, elect not to) consult central server 12 to retrieve messages on demand, and messaging nodes 14 may be too large for the provision of all incoming messages to all members of messaging nodes 14. Central server 12 uses association table 80 to anticipate the origin of future message retrieval requests, and proactively delivers new messages to the specific locations where the user can reasonably expected to seek the collection of new messages.

When central server 12 receives a message for delivery to a user of messaging system 10, central server 12 consults association table 80 associating each user with a primary messaging zone 82, and buffers the incoming message for transmittal to each member of primary messaging zone 82 at the next available communications opportunity over the respective first communications link 70. This brings the message to each member of primary messaging zone 82 at the earliest opportunity. There are several similar methods for implementing this function. For example, in a message keyed implementation, a primary messaging zone 82 dependent on the recipient(s) is generated or consulted upon the receipt of an incoming message, and the incoming message is placed in a delivery list for each messaging node 20 within primary messaging zone 82. In a node keyed implementation, upon a communications availability with messaging node 20, association table 80 is consulted to determine for which user accounts messaging node 20 falls within primary messaging zone 82, and incoming messages for those accounts are placed in a delivery list for messaging node 20, which falls within primary messaging zone 82 for each such message. These database operation examples will suggest similar implementations to a person of ordinary skill in the art.

To collect new messages, the user must bring portable messaging unit 40 to the immediate physical proximity of a messaging node 20, preferably a member of primary messaging zone 82. A data exchange 90 between messaging node 20 and portable messaging unit 40, as described above in the case of the upload of a message, also triggers the download of any new messages stored on messaging node 20 for the user(s) of portable messaging unit 40. This is not necessarily a current image of all new messages within messaging system 10, because some messages may remain buffered at central server 12 for future delivery to this messaging node 20, or may be buffered at other locations within messaging system 10, such as another messaging node 20 or another portable messaging unit 40.

If the user brings portable messaging unit to a foreign messaging node 86 not within primary messaging zone 82, messaging node 20 can be expected to have no knowledge concerning new messages directed to the user. This foreign messaging node may be used normally for the upload of outgoing messages, and optionally foreign messaging node 86 may initiate a request to central server 12 requesting the delivery of incoming messages, but special actions are required to collect messages from foreign messaging node 86. Several such actions are possible. For example, the user may request that foreign messaging node 86 be joined to primary messaging zone 82, so that a subsequent communication session between foreign messaging node 86 and central server 12 results in a current set of incoming messages becoming available at this messaging node. In another example, the user may request that foreign messaging node 86 be given, on a one-time or temporary basis, copies of incoming messages for the user. In still another example, such actions may be initiated automatically by messaging system 10 upon user access of a foreign messaging node 86.

User Messaging Accounts

Messaging system 10 provides for an abstraction layer between portable messaging units 16 and user messaging accounts, such as e-mail accounts. A user may configure any portable messaging unit 40 with personal account information, such as a username and password, and thereafter send and receive messages over the indicated user messaging account. Similarly, a user may delete a user messaging account from a portable messaging unit 40. A portable messaging unit 40 may also be configured to support multiple user messaging accounts. In this configuration, a data exchange 90 will upload and download messages relating to all indicated user messaging accounts. Portable messaging unit 40 may provide password protection for accessing operations relating to a specific user messaging account.

While under ordinary circumstances a user may utilize a single personal portable messaging unit 40, it is also possible to borrow or rent an unfamiliar portable messaging unit. For instance, an Internet cafe might offer loaner units, analogous to a “copier key” at self-service copy centers, for use within the business facilities. Since a user can simultaneously have more than one portable messaging unit 40 configured to a single user messaging account, it may be desirable to have the option of indicating upon message collection that received messages should not be deleted from messaging node 20, central server 12, or other distribution nodes within messaging system 10. It may also be desirable to provide means for transferring stored messages between two members of portable messaging units 16.

Users of messaging system 10 may create message filters associated with specific user messaging accounts, to provide services such as message blocking, prioritization, redirection, forwarding and sorting. Such rules may reside on central server 12, messaging node 20 or portable messaging unit 40, and affect the disposition of incoming messages as they are received at the system element holding the relevant rules.

Prioritization Rules

In ordinary networks, data existing on a network will reside at certain locations, but will not reside locally at all network nodes. Network resources are limited, including storage capacity at the nodes, and communications capacity across network communication links. If a network node can quickly and reliably request data on demand, this is not very important. But in a network environment with unreliable or intermittent communications, it may be essential to proactively buffer network data locally, for use at times when the data would otherwise be inaccessible. Since it is not usually practical to buffer all network data at the local nodes, some system must be implemented to select messages or other data for proactive buffering, retention or transmission.

Within messaging system 10, prioritization rules may be employed to:

a) ensure that higher priority data is transmitted first during communications sessions between a sending node (central server 12) and a receiving node (messaging node 20), to optimize data value if first communications link 70 unexpectedly disconnects before the intended data exchange has completed;

b) create a plurality of zones within messaging nodes 14 reflecting, for a given user, a graduation of value in having message data available for that user. Messaging system 10 may not know which member of messaging nodes 14 a user will visit to retrieve messages. In this circumstance, it may be advantageous to send all incoming message data to a primary messaging zone 82, and send a data subset comprising only higher priority message data to secondary messaging zone 84 comprising messaging nodes with a lower probability of usage. As is evident, such a method may employ an arbitrary number of zones, and

c) defer lower priority data to a subsequent communications session, if the load on central server 12 exceeds a predetermined threshold, or if the cumulative traffic with central server 12 approaches the collective communications bandwidth capacity of the Internet connection serving central server 12, or if transmission of all data to a messaging node 20 would exceed a limited resource, such as storage capacity at messaging node 20 or communications time over first communications link 70.

In each of these examples, it is desirable to discriminate between high-priority and low-priority messages, or elements of messages. The full text of an incoming message may be decomposed into a plurality of message elements of different types, such as a header, a first message section corresponding to a limited initial section of the incoming message, and a second message section corresponding to the remainder (if any) of the incoming message. By placing these message elements in descending priority sequence, by rank of a prioritization value, messaging system 10 can reduce the problem of long e-mail clogging the system for other users, or complicating the delivery of other messages to the same user. For many common messages, a header (such as a sender's messaging address, and a subject line) may be sufficient to convey the essential information of a message.

To establish messaging zones, central server 12 administers an association table 80 database relating a zone code to a messaging node/user pairing. Message zones may be custom configured by the user; selected from predetermined options corresponding to geographic, political or transportation messaging node groupings; or automatically determined by means of a predictive algorithm responsive to user behavior. Such an algorithm might determine a predicted probability, based upon prior behavior, that the user will request the collection of incoming messages at particular messaging nodes. These messaging zones may be dynamically responsive to user behavior or network conditions, and may reflect predetermined thresholds for a computed message prioritization value. A simple user configuration option comprises pressing home button 36 while portable messaging unit 40 is at docking ports 26, which inserts messaging node 20 into primary messaging zone 82.

The full text of a message may be delivered expeditiously to primary messaging zone 82, while a limited subset of message elements (such as headers) may be provided to secondary messaging zone 84. In this zone, a user collecting messages may be informed that a message exists—or perhaps be provided with the first message section—without being provided the full message text. Messaging system 10 should not delete partially received messages, or at least uncollected sections thereof, so that such messages can later be collected and displayed in their entirety.

In general, the availability of a specific message element, at a specific messaging node, for a specific user, will have a certain value as a function of several variables such as (a) the zone identification from association table 80 relating this user and this messaging node; (b) the type of message element involved; (c) whether the message element matches certain prioritization rules associated with a user messaging account; (d) the service level of the sender and/or receiver; (e) the age of the message; (f) an optional ‘express’ surcharge for faster or wider ‘express delivery’; (g) whether the message element is an administrative message related to an administrative function; and (h) the geographic location of the messaging node 20. The prioritization value for each message, or message element, will reflect all or some of these factors.

When communication is available between central server 12 and messaging node 20, selected messages or message elements would be transmitted in order of priority until some system limited resource (such as connection time, connection bandwidth, server time, storage capacity) becomes unavailable or ceases to be cost effective. Similar prioritization rules may be employed for sequencing outgoing messages, and prioritizing the upload and download of messages, although zone codes do not apply in this circumstance. Some messages, especially large media files such as images or audio samples, may be split into multiple pieces for delivery over several communications sessions.

Distributed Mail Deletion

When an incoming message is successfully delivered to the user, there is ordinarily no reason for the message to be retained by any element of messaging system 10, excepting the user's portable messaging unit 40. Thus, collected messages may be deleted from the messaging node 20 where the message was collected, as well as other members of messaging nodes 14 or central server 12 that have copies of this delivered incoming message.

When messaging node 20 deletes an incoming message due to successful delivery to a portable messaging unit 40, messaging node 20 generates an administrative message for central server 12 indicating that this message was delivered. This administrative message is buffered for future delivery during a server/messaging node communications session. Upon delivery, central server 12 deletes its copy of said incoming message, generates a message for each messaging node holding a copy of said incoming message indicating that these nodes may delete the message, and buffers these messages for future delivery during communications availabilities.

In some circumstances, portable messaging unit 40 may indicate that messages should be retained, despite successful delivery to portable messaging unit 40. For example, a user may be borrowing a portable messaging unit 40 from an Internet cafe or friend, want to review new messages, but also want to later download these messages to a primary portable messaging unit 40. In this instance, the user may request that messaging node 20 leave incoming messages on the network.

In some circumstances, node computer 22 may have no reason to notify central server 12 regarding the successful delivery of a message. For example, if a message of local interest (such as a public safety notice, or advertisement) is marked as for delivery from only messaging node 20, and it is known that the delivered message was not buffered at central server 12 or other messaging nodes, there is no need to initiate the deletion of the message there. However, if applicable, messages regarding tracking and billing information may still be generated for delivery to central server 12.

In some circumstances, distributed mail deletion may be triggered by some other condition. For example, if a message is not collected for longer than a predetermined interval, it may be removed from messaging system 10 due to an expectation that the user has abandoned an account, or otherwise will not retrieve the message. In addition, messaging node 20 may elect to delete its buffered copy of a message, without triggering a distributed mail deletion, in the event of storage limitations or if the message is not collected in a reasonable period.

Latency Report

When messaging nodes 14 typically have only intermittent communications with central server 12, there may be substantial delays in the propagation of messages through messaging system 10. Users may want to know the freshness and completeness of reported messages, or have a sense of the probability of mail not yet available, when collecting new incoming mail.

To give the user some sense of the current latency periods, messaging node 20 may report during data exchange 90 the time of the last activity across first communications link 70, indicating the most recent time when new incoming messages might have been collected from central server 12. For example, portable messaging unit 40 might report that the last update to messaging node 20 was at 4 am, local time, on that day. Thus, the user would know that any incoming messages sent later in the day (possibly excluding messages sent from messaging node 20 itself) are not yet available at messaging node 20.

Messages sent user-to-user within messaging system 10 generally travel twice across instances of first communications link 70—once when the message is sent to central server 12 for distribution, and again when the message is buffered at the messaging node 20 from which the message is subsequently delivered to the recipient. Thus, messages sent simultaneously from several members of messaging nodes 14 might be proactively buffered at messaging node 20 at considerably different times, depending on the phasing and frequency of these nodes' communications with central server 12.

To represent this more complex environment, it may be useful for a latency report to indicate a percentage of messaging nodes 14 from which messages would have been delivered during data exchange 90, if sent within a time period (such as the last 24 hours). The report may focus on all members of messaging nodes 14, or some subset, such as nodes within a geographic region, or members of primary messaging zone 82. For example, messaging node 20 could report that messages sent from 80% of messaging nodes 14 within the state of California in the last 24 hours would have been delivered in this data exchange 90. Such information would give the user a reasonable impression of the freshness and completeness of the incoming messages provided, and what may be presently unavailable for collection.

For messaging node 20 to generate reports going beyond the time of the last collection from central server 12, central server 12 may provide messaging node 20 with information (probably statistical) regarding the time distribution of last updates between members of messaging nodes 14 and central server 12.

Account Payment and Validation

To use messaging system 10, users must pay usage fees. For security reasons, it is preferred that usage fees be pre-paid with an account credit balance stored authoritatively by central server 12, with said balance deducted with usage, although other billing processes may be employed, including post-pay options. Pre-payment credit may be purchased through on-line payments, such as credit card transactions or PayPal money transfers, or directly from local sales representatives or vending machines. An account balance may be related to a single user messaging account, or to a plurality of related user messaging accounts.

Credits may be charged for message traffic, and the system may be configured to charge the sender, the recipient, or both. Options may be provided for “collect messaging”, where messages may be sent at no charge, but cannot be received or displayed without the recipient accepting the charges. Surcharges may apply for messages sent with an unusual prioritization level, long messages that consume greater communications or storage resources, or a user request for an immediate special connection to central server 12 (such as for rapid messaging services, or services at a foreign messaging node 86). Accounts may operate at several service levels, providing different functionalities, different zone coverages, and message priority default ratings.

At some time before a message is delivered to a recipient, central server 12 must validate that the relevant credit limits are not violated, and update administrative records to record the additional traffic related to the user messaging account. If the delivery of a message is denied, a delivery failure message should be generated so that the sender is made aware that the message was not delivered. A delivery failure message may also be provided to the intended recipient, together with a reminder to pay for continued service.

Central server 12 will clearly have the opportunity to validate messages that pass through that server prior to delivery. This is the usual circumstance, excepting messages that are delivered to other users of messaging node 20 without first passing through central server 12. To facilitate the rapid availability of such local messages, as central server 12 may not be accessible on demand to validate user credit, provisional credit information may be cached on selected members of messaging nodes 14. This cached information may also be used to notify users of possible (but not confirmed) credit problems that may inhibit message delivery.

If central server 12 detects that an account balance is low or expired, it generates an administrative message for affected user messaging accounts notifying the users of the situation, and encouraging the users to pay for additional service. When a user provides payment through a local facility, central server 12 will be notified as soon as practical, but may not know right away. Thus, central server 12 should not immediately deny message traffic, but should hold them sufficiently long for payment notification to arrive. If payment is made together with system access to portable messaging unit 40, such as at a messaging node 20 with payment acceptance means, portable messaging unit 40 may “learn” that payment has been made to temporarily suppress visible error messages. However, to prevent fraud, information provided by portable messaging unit 40 should not be sufficient to validate payment for message traffic.

Portable Messaging Unit

Portable messaging unit 40 serves as the user interface for messaging system 10, and is used for the reading, storage, maintenance and composition of messages. Portable messaging unit 40 includes firmware, comprising a program module stored on ROM 56 in a computer-readable format, for controlling messaging operations. The use of a dedicated messaging device, with firmware for low-cost and stable operations, permits a device design that is specifically optimized for the specific functions required, without superfluous materials and features.

Portable messaging unit 40 is usually off, to conserve the charge on battery 46. Portable messaging unit 40 may be turned on by pressing power button 58, and the same button may be pressed to turn the unit off. When power is disconnected for any reason, such as user operation, inactivity timeout, or a low battery condition, portable messaging unit 40 saves the current state of the user interface, and automatically resumes from the same condition upon the restoration of power.

Messages are physically stored in non-volatile memory 52, and are conceptually stored in one of three folders, labeled “inbox”, “archive” and “outbox”. The user may access any of these folders in a basic interface mode by pressing a button with that name, such as inbox button 60, archive button 61, or outbox button 62. The inbox folder conceptually holds all messages acquired at the last visit to messaging node 20, the archive folder conceptually holds all older incoming messages that remain on the device, and the outbox folder conceptually holds all messages prepared for upload (but not yet sent) since the last visit to messaging node 20.

At data exchange 90, all contents of the inbox folder are moved to the archive folder. Messages in the outbox folder are deleted upon receiving a confirmation from messaging node 20 of successful upload to messaging node 20. New incoming messages are placed in the inbox folder, and if insufficient storage space is available in non-volatile memory 52, the oldest messages are deleted from the archive folder until sufficient memory becomes available. If this operation does not free sufficient memory, some incoming messages will not be retrieved and will not be deleted from messaging node 20, and first CPU 50 will place a report of this error on user output device 44. In this case, it may still be possible for portable messaging unit 40 to download some higher priority messages or message elements, such as headers only. By assessing memory constraints early in data exchange 90, it can be assured that available memory is used optimally.

When accessing a folder, the user is initially presented with a summary screen, indicating the folder name and the number of messages within the folder. The user may then step through the messages using sequence buttons 68, scrolling through each message with scroll buttons 69. The order of sequence buttons 68 forms a loop, with the summary screen serving as both first and last message. When accessing the outbox folder, the summary screen shall indicate a manner of creating and editing a new message, such as pressing the right button of sequence buttons 68 once; following keypresses take you through saved messages in this folder. When viewing any message in this folder, the user may edit the currently displayed message. When accessing the inbox or archive folders, the user may initiate a reply (and enter an editing mode for composing a new message) by pressing reply button 64. In any folder, the user may erase a message by pressing delete button 65, and confirming the request with an indicated action.

When accessing a message in the inbox or archive folders, pressing address button 66 copies the sender's address to an address book maintained in non-volatile memory 52. When accessing a message in the outbox folder, pressing address button 66 calls up the address book, and the user may use scroll buttons 69 to select an address to add as a message recipient. When accessing the address book, the user may delete unwanted entries with delete button 65, or protect entries from accidental deletion with hold/save button 63. Protected entries may also be brought to the top of the address book list, for easier access to more important entries.

All messages have an associated hold flag, indicating protected status. Messages with a set hold flag shall not be automatically deleted to free memory in data exchange 90, and erase requests with delete button 65 shall be blocked. At the time of data exchange 90, messages in the outbox folder with a set hold flag shall be copied to the archive folder, in addition to standard upload. The hold flag status of any message may be toggled on/off with hold/save button 63.

Portable messaging unit 40 shall also provide a menu-based user interface, with some functional resemblance to the Pine e-mail utility familiar to users of UNIX computing environments. The top layer of the menu structure provides a set of options, including access to each folder; a help option, providing access to basic help information stored on ROM 54; a display option, for adjusting parameters of user output device 44, such as brightness, contrast, viewing angle, font, and text size; and an account settings option, for adding, deleting or editing information respecting user accounts accessed through portable messaging unit 40; address book maintenance, for editing or manually adding entries; and a group delete option, used to erase various sets of messages based on folder and hold flag status. When accessing folders through this interface option, a list of messages shall be presented, indicating the sender (for outbox, recipient) of each message, together with a subject line or message size. The user may scroll through this list with scroll buttons 69, display a current message with the right button of sequence buttons 68, or return to the prior level of the menu structure with the left button of sequence buttons 68. The user may be able to generate or remove user-defined message folders by accessing a folder maintenance option from the menu.

This menu system may be accessed at any time by pressing menu button 67. From a summary screen, or if pressed twice in close succession, portable messaging unit 50 will revert to the top level of the menu. If pressed once while viewing a message, the user will be taken to the menu message listing of messages within the current folder, with the current message highlighted. While viewing a message, since menu button 67 provides similar functionality, sequence buttons 68 may revert to their ordinary functionality in the basic interface mode.

At power-up, or on request from the menu, portable messaging unit 40 will show an account status screen, indicating information such as billing credit status, number of messages in each folder, number of unread messages, amount of non-volatile memory 52 used or remaining, or similar information. A small quantity of non-volatile memory 52 may be reserved for incoming system messages or new outgoing messages, and not considered free for the download of general priority incoming messages.

Non-Text Data Formats

The most basic application of messaging system 10 is for text messages, but other graphical or custom data types may be supported, and messages containing these data types may be processed and delivered similarly. User output device 44 may be used for the representation of simple graphics or simple icons, which may be embedded within messages, and retrieved from either the message content or an enumerated list of standard symbols available on portable messaging units 16. This capacity is significantly enhanced if user output device 44 is capable of showing grayscale. If configured with speaker 56, portable messaging unit 40 may permit volume adjustment using scroll buttons 69, and may permit a default volume setting (including off) through the display options of the menu system. Portable messaging unit 40 may optionally be responsive to requests embedded within messages via a markup language, such as HTML or other similar language, requesting enhanced display attributes such as graphics, icons, audio, and adjustments to font style and size. The unit's response to these requests may also be altered via the menu system options.

Messaging system 10 may transmit occasional or periodic update messages to all users, or a subset of users selected for characteristics such as geographic location, where said updates include information such as news, new icons or graphics, or audio files. System media messages may be utilized for creating entertaining display properties, such as audio samples that the user may elect to have played in response to certain operations or events.

Notepad

Portable messaging unit 40 may include a notepad function, in which a composed message (‘note’) is not associated with a recipient, and is not transferred to messaging node 20. Such notepad messages may be retained until an explicit deletion request, or may be retained for only a predetermined time from note generation, depending on user configuration settings. Portable messaging unit 40 may include means for later associating a recipient with a note, converting the message into an outgoing message for processing in the ordinary fashion.

Notes may be initiated, composed and stored in a manner analogous to an outgoing message, although the sorting of outbox messages may make notes contiguous. Alternatively, an additional ‘note’ key may be included on the user interface, providing access to a ‘note’ folder, or such a special folder may be accessible only from the menu.

Other functions unrelated to messaging, but of general interest to consumers, may also be incorporated into portable messaging units 16. Examples include a calculator function or a simple game.

Data Exchange

During the docking of a portable messaging unit 40 at messaging node 20, a data exchange is conducted between second CPU 28 and first CPU 50, via second communications link 72 utilizing first infrared transceiver 30 and second infrared transceiver 48. FIG. 6 shows a flowchart of data exchange 90 whereby second CPU 28 interacts with node computer 22 to store and retrieve messages, and perform other administrative functions. The operational functions of node computer 22 and second CPU 28 may be divided in any of several ways, and while the following is a description of a preferred division of functionality between these processing units, other divisions will be evident to a person of ordinary skill in the art.

At the start of data exchange 90, at step 91, CPU 28 detects the placement of a portable messaging unit 40 in one of docking ports 26. This detection may comprise noticing an infrared signal from portable messaging unit 40, or a physical contact with a microswitch. In step 92, CPU 28 establishes the identity of user accounts associated with portable messaging unit 40, and performs account verification functions. In step 93, portable messaging unit 40 transfers outgoing messages to messaging node 20. This is done at an early stage to free non-volatile memory for the storage of new incoming messages subsequently received. In step 94, portable messaging unit 40 reports the amount of free non-volatile memory available for the storage of new incoming messages, and in step 95 messaging node 20 applies a prioritization algorithm, selecting messages for transfer if the memory is insufficient for the storage of all new messages. Then, in step 96, messaging node 20 transfers these selected messages to portable messaging unit 40. Finally, in step 97, status light 32 indicates the transaction completion of data exchange 90, at which time the user may remove portable messaging unit 40 from docking ports 26.

Portable messaging unit 40 uploads any outgoing messages to second CPU 28, which further conveys said outgoing messages to node computer 22 for temporary storage in nonvolatile memory. Once successfully stored on node computer 22, a message is sent to portable messaging unit 40 indicating that this message has been recorded. Depending on user settings, portable messaging unit 40 may then automatically delete said outgoing messages from its memory, to free memory for the storage of other data. Alternatively, if the message is retained, the message may be marked as sent, to inform the user and inhibit further sending attempts.

Second CPU 28 retrieves any incoming messages stored in non-volatile memory on node computer 22 addressed to any user account associated with portable messaging unit 40, and transmits said incoming messages to portable messaging unit 40, which then stores said incoming messages in its non-volatile memory for later user retrieval. Portable messaging unit 40 confirms the receipt of these incoming messages to second CPU 28, and indicates whether these messages should be deleted or retained. Ordinarily, second CPU 28 will pass an instruction to node computer 22 to delete said incoming messages from its non-volatile memory to free such memory for the storage of other data.

Data exchange 90 may also include administrative functions, such as submitting user-requested changes to the account associations, receiving current billing information, etc.

At the end of a data exchange 90, status light 32 is illuminated to indicate that the user may remove portable messaging unit 40 from docking ports 26. To provide greater information (such as reporting the number of new messages, or reporting error conditions), portable messaging unit 40 may display a transaction summary, or status light 32 may be configured to provide some minimal data (such as an eight-segment display of new messages received, or lights of different colors to indicate error conditions).

If messaging node 20 has access to a viable real-time first communications link 70, messaging node 20 may, during data exchange 90, request incoming messages for a user account subsequent to the identification of the user account to messaging node 20. This request may be directed to central server 12, or an external mail server such as a POP account identified by the user with mail server information (such as IP address, username and password). In either case, this allows for the immediate delivery of recent incoming messages to portable messaging unit 40. This service may be viable at some of messaging nodes 14 and not others, depending on the quality, reliability and cost of first communiatons link 70. Messaging system 10 may optionally restrict the service to certain users, or impose a surcharge for such immediate delivery.

Data Format

Third communications link 74 between node computer 22 and second CPU 28 may use a standard intercomputer data protocol, such as RS-232 serial data over a serial data cable. Second communications link 72 between distribution interface 24 and portable messaging unit 40 may use a custom data format. To increase security and privacy, messages may be encrypted during transmission and storage outside portable messaging unit 40. At a minimum, data may be stored in a proprietary format that is generally resistant to deciphering without specific encoding/decoding algorithms incorporated into the portable messaging unit 40 devices.

Alternate Message Access and Transport

Under some conditions, it may be desirable for a user to enter or receive a message directly from node computer 22, without use of a portable messaging unit 40. For example, administrative functions may be performed directly at node computer 22, including the sending and receiving of administrative messages, whereas ordinary users are required to utilize portable messaging units 16 for reasons of throughput efficiency. Similarly, a messaging node 20 user interface might be made available to users who are traveling without a portable messaging unit 40, or are using private or low-traffic messaging node 20 facilities. Such user activity may be performed concurrently with ordinary usage of docking ports 26 by a plurality of users.

In some applications, it may be known that all recipients of a message will collect messages from the specific messaging node 20 where the message was uploaded or generated. In this situation, it is not necessary to pass the message to central server 12 for distribution, although central server 12 may still be involved for administrative, message tracking or user account billing functions.

A pair of devices from portable communication units 16 may be configured to exchange data directly between the devices, by a direct link between the respective second infrared transceiver 48 of each portable messaging unit 40. Such a connection may be used to exchange messaging system addresses for the current user account on each device, with such information appearing as a new message in the user's inbox folders. In another configuration, the received messaging address is added to the recipient's address book. In addition, this technique may also be used to transmit a message from the sender's outbox folder, or clone the account and message data of one portable messaging unit 40 onto another similar device. In general, portable messaging units 16 may be able to communicate with other devices of the same type, or with messaging nodes 14, but are not designed for communication with any other electronic devices.

In a non-realtime format, messaging system 10 may provide access to advanced network functions, such as network webpage retrieval including an implementation for Internet search requests; complex mathematical functions; weather forecasts; and similar network services. Portable messaging unit 40 sends a message to a processing service, optionally located at central server 12, that performs the indicated function. The processing service returns the result in the form of an automated message to the user who initiated the request. The response is typically not returned to the user immediately, but is buffered in the manner of other incoming messages for subsequent collection from messaging nodes 14.

Advertising Messages

In general, spam should be discouraged in messaging system 10, as bulk messages consume limited communications and storage resources. This is especially important in configurations where recipients are charged for incoming message traffic. To limit spam, several restrictions may be imposed, such as (a) blocking all e-mails with more than a limited number of “To:” or “CC:” e-mail destinations within messaging system 10, excepting mailing lists authorized by network administration; (b) blocking e-mails with more than a limited number of “BCC:” destination addresses within messaging system 10; and/or (c) blocking email traffic sent from known or suspected spammers.

Advertisers may be permitted to use messaging system 40 for bulk messages, provided that (a) a special surcharge is applied, (b) recipients have the option of blocking such advertising messages, possibly for a surcharge; (c) recipients are not charged for such message traffic, regardless of other account, billing or network configurations; and (d) such advertising messages are given a low priority when system resources are limited.

Quasi-Broadcast Messages

Messaging system 10 may quasi-broadcast messages, such as daily news, certain advertisements, updates to the appearance and content shown on messaging node display monitor 34, and sound “jingles” which may be used to create signature “brand” characteristics or customized portable messaging unit characteristics. These messages are not explicitly addressed to specific user accounts, but are similarly distributed to messaging nodes 14, where portable messaging units 16 may access this information in a manner analogous to the collection of incoming messages. A portable messaging unit 40 may request specific messages, messaging node 20 may know the identities of specific user accounts which should receive such messages, or messaging node 20 may deliver such messages to all user accounts that access the node.

If optional display monitor 34 is incorporated into messaging node 20, it may display information in a general broadcast to any users or passers-by of messaging node 20. This may include advertising, system service announcements, administrative notices, general news, or public service information. In addition, display monitor 34 may also indicate the status of data exchange 90 at each of the active docking ports 26, including optionally the functions of status light 32.

Central Server

Central server 12 provides several functions supporting and coordinating messaging system 10.

Central server 12 manages several databases including:

a) a user account database, which reflects the status of each user account. Information includes username and password; general contact and identity information such as name, address and telephone number; service level; active or inactive account status; credit status; and a conduct flag used to indicate known or suspected spammers.

b) a messaging node database, which reflects the status of each of messaging nodes 14. Information includes a node identifier; general contact and location information; maintenance contact information, such as a name, address and telephone number of someone to contact in the event of a messaging node malfunction; statistical information such as traffic quantity, connection reliability and connection bandwidth; and communications information indicating limits on communications time available to an individual messaging node, and scheduling information if it is desired that central server 12 initiate periodic communications sessions.

c) an association table database, which reflects the association of specific user accounts with specific messaging nodes.

d) a message status database, which reflects the status of each message transported through central server 12. Information includes senders, recipients, delivery status to messaging nodes within a messaging zone determined for the message, delivery status to recipients of the message, and age of the message.

Central server 12 provides several authoritative functions within messaging system 10, including:

a) Accounting authority. All accesses (whether from user accounts via messaging nodes 14 inside the system, or in the form of messages received from the Internet and destined for user accounts) are verified against the user account database to determine that the user account is valid, and has sufficient credit for the requested messaging traffic. Central server 12 may also update credit information to reflect the usage of messaging system 10 for this traffic.

b) Prioritization authority. Messaging traffic from central server 12 to messaging nodes 14 are prioritized for transmittal during communications opportunities. This process may consult the messaging node database and the association table database to determine the best mode of delivery for a given message in the message status database. Modes of delivery include full and prompt transmittal of a message, delivery of selected message elements only, or the breaking of a message into two or more components for transmittal during different communications sessions.

Central server 12 provides several services within messaging system 10, including:

a) SMTP or similar service, for bi-directional messaging gateway services with external messaging systems. If the accounting authority function of central server 12 determines that this traffic may be passed, the messaging traffic is passed to its destination.

b) POP or similar service, for the delivery of incoming messages. These messages may be collected at messaging nodes 14, or other Internet clients that may be available to users. If the accounting authority function of central server 12 determines that this traffic may be passed, the incoming message is passed to its recipient. Otherwise, the message is bounced to the sender.

c) Proactive message delivery service. Initiates communications sessions to selected members of messaging nodes 14, in accordance with scheduling information in the messaging node database, and delivers messages from the message status database for user accounts associated with a messaging node in accordance with the indications of the prioritization authority function and the association table database.

d) Periodic update service. Provides low-priority system information and messages to broad classes of messaging nodes 14, such as daily news, certain advertisements, updates to the appearance and content shown on messaging node display monitor 34, and sound “jingles” which may be used to create signature “brand” characteristics or customized portable messaging unit characteristics. This relies heavily on prioritization authority feature to distribute these sometimes large files to the messaging nodes without disrupting normal communications by overloading a network resource such as central server 12 bandwidth or excessively loading a network resource such as communications time over first communications link 70.

Central server 12 may also provide additional standard methods for accessing user accounts and messages related to user accounts, including the sending and receiving of messages through a webmail interface, as a supplemental service.

Messaging system 10 may employ a variety of network structures. For example, central server 12 may comprise a set of interconnected computers jointly performing the indicated tasks, a multilevel network architecture with regional message distribution and administrative servers, mirroring on unrelated subnets to provide greater reliability against Internet service problems, or similar network architecture implementations known to persons skilled in the art. In a multilevel message distribution tree network, communications across unreliable or intermittent network connections may employ techniques described herein for providing messages between a network subtree and a higher network element, and communications across reliable and continuous network connections may employ conventional on-demand communications methods. A multilevel network architecture may also reflect a configuration of computers and servers at a central messaging facility.

Alternative Embodiments

In an alternative embodiment, messaging nodes 14 comprise a single messaging node 20 together with a plurality of portable messaging units 16, and the functions of central server 12 are performed by this single messaging node 20. This is the simplest embodiment of the present invention, but restricts the geographic mobility of users in comparison to the preferred embodiment.

In another alternative embodiment, first communications link 70 is presumed to be reliable and continuously available, such that communications between central server 12 and members of messaging nodes 14 may be conducted on-demand. In such a configuration, the asymmetry between message upload and download vanishes, as the special requirement for proactive buffering of incoming messages at messaging node 20 does not apply. Thus, messaging in either direction may be conducted in a single manner, similar to that described in the preferred embodiment for upload. Proactive buffering may still be employed for the purposes of network traffic load distribution or message access speed enhancements, and messaging zones may still be employed for billing purposes, but such aspects do not drive the operation of messaging system 10, and may be omitted.

In another alternative embodiment, members of messaging nodes 14 may undertake peer-to-peer communications, not routed through central server 12, or other higher node in a multilevel message distribution tree network. Members of messaging nodes 14 may have some local knowledge of association table 80 to assist in optimizing such peer-to-peer communications, or members of messaging nodes 14 may simply share any messaging information with related messaging nodes, such as all other nodes within a geographic region, or other messaging node groupings as discussed in relation to the automatic selection of messaging node zones.

In another alternative embodiment, second communications link 72 is implemented with alternate communications means known to persons skilled in the art, for conducting data exchange 90 between docking ports 26 and a portable messaging unit 40. For example, data transfer may be conducted over a direct temporary data cable connection such as a serial data cable, or transceivers may be employed using visible or ultraviolet light, supersonic communications, or extremely low-power radio frequency communications with a range limited to docking ports 26 or an immediate environment of messaging node 20, such as a room, passageway or other immediate proximity, not exceeding 100 meters. Infrared (IR) communications are generally preferred to direct cabling because cables must be frequently connected and disconnected, and such a stress point would adversely affect system reliability. IR is preferred to radio, because radio may be unreliable in environments with interference, and may create regulatory side-effects regarding licensing and type acceptance. In contrast, IR within docking ports 26 has the benefit of creating a clear-channel data connection with each portable messaging unit 40, with less signal impurity from environmental ambient signals or crosstalk with similar elements of messaging system 10.

In another alternative embodiment, docking ports 26 are omitted. Second communications link 72 between docking interface 24 and portable messaging unit 40 is conducted via line-of-sight photonic communications means such as infrared, visible or ultraviolet transceivers, and data exchange 90 is triggered by the presentation of portable messaging unit 40 to a line-of-sight proximate zone about distribution interface 24. For example, messaging node 20 including distribution interface 24 may be mounted at a high position within a passageway, such that exposed portable messaging units carried through this passageway can automatically conduct data exchange 90 without any additional user intervention.

In another alternative embodiment, docking ports 26 are omitted, second communications link 72 is conducted over a low-power radio frequency communications channel, with power limited such that (a) communications are limited to a proximate region immediately about messaging node 20, such as a specific room or public gathering area; (b) no directional antenna is required for data reception; and (c) transmission power is limited such that no radio frequency transmission license is required for operation at that frequency and geographic location. It is desired that such communications be strictly limited to a small region proximate to messaging node 20, such as line-of-sight visibility to the physical equipment of distribution interface 24 at a ground-level or indoor location ordinarily accessible to human access and activity. Wider communications may create a number of undesirable complications, such as licensing and interference, generating an expectation of reliable and instant messaging that is not appropriate for this network architecture, and coordinating timesharing between numerous portable messaging unit 40 devices that may want simultaneous access to messaging system 10.

In another alternative embodiment, some or all elements of messaging node 20 described as separate electronic devices in the preferred embodiment are integrated into a single device. For example, a custom product could combine distribution interface 24 and node computer 22, providing docking ports 26 and (if desired) display monitor 34. This integrated device would also include means for operating first communications link 70.

In another embodiment, the verification of credit status is performed by messaging node 20 from information stored on portable messaging unit 40, without the participation of central server 12. To deter fraud, at least one aspect of data exchange 90 (such as a handshaking proceedure, message data or verification information) should be encrypted, preferably with an encryption dependent upon a reference key provided by said messaging node 20.

Ramifications and Scope

Accordingly, the reader will see that the messaging system of the present invention improves messaging system efficiency, by enabling access to a messaging system from a plurality of geographically distributed messaging nodes, using low-cost firmware-based portable messaging units without sophisticated communications equipment. These communications are conducted via proximate communications means not requiring a license, not subject to mechanical wear, and capable of simultaneously serving a plurality of users from a single messaging node. The separation of user interface activity from an expensive messaging node computer, and relocation of such activity to the low-cost portable messaging units, enables more efficient usage of the messaging nodes. This further allows multiple users to simultaneously conduct user interface activities in conjunction with their usage of a single messaging node for the communcation of data in a messaging system. The parallelism of this system permits the amortization of the costs of owning and operating a messaging node across a large number of messaging system users, who engage in brief data exchanges with said messaging node as a gateway to the outside world, but otherwise conduct user interface functions on low-cost firmware-based portable messaging units. Thus, the present invention permits low-cost devices to provide user interface functions, without requiring simultaneous access to other messaging system elements, such as messaging nodes.

While the above description includes many specificities, these should not be construed as limitations on the scope of the invention, but rather as an exemplification of one preferred embodiment thereof The variants presented in the alternative embodiments, as well as the elements mentioned in the dependent claims, may be combined in various combinations obvious to a person with ordinary skill in the art, in light of the concepts described and suggested herein, and such variants are intended to fall within the scope of the present invention. Many other variations are also possible. Accordingly, the scope of the invention should be determined not by the embodiments illustrated, but by the appended claims and their legal equivalents.

We claim:

1. A messaging system means comprising a plurality of messaging nodes, a plurality of user accounts with distinct messaging address identifiers, and a plurality of portable messaging units including
a) storage means for firmware for controlling messaging operations;
b) storage means for the storage of messages;
c) composition means for the composition of messages;
d) display means for the display of messages;
e) associative means for associating at least one of said portable messaging units with at least one of said user accounts, and
f) communications means for conducting a data exchange with a messaging node, when in an immediate proximity of said messaging node;
whereby a plurality of said portable messaging units may conduct two-way messaging via said messaging system when in said immediate proximity to at least one messaging node of said messaging system, and conduct user interface functions irrespective of location.

2. The means of claim 1, wherein a plurality of said portable messaging units are each capable of conducting said data exchange at a plurality of said messaging nodes.

3. The means of claim 1, wherein a plurality of said messaging nodes include a plurality of docking ports each accepting portable messaging units.

4. The means of claim 1, wherein said messaging system further comprises a central server gateway for all messaging traffic between said portable messaging units and the Internet.

5. The means of claim 1, wherein said messaging system further comprises a central server with means for tracking and billing messaging traffic between said portable messaging units via said messaging nodes.

6. The means of claim 1, wherein said data exchange conducted between said portable messaging units and any network requires that said portable messaging units be physically transported to said immediate proximity of at least one of said messaging nodes.

7. The means of claim 1, wherein the transfer of data between a portable messaging unit within said messaging system and any other type of electronic device requires that said transfer of data be conducted via said data exchange with said messaging node.

8. The means of claim 1, wherein said data exchange is conducted via photonic communications means.

9. The means of claim 1, wherein said data exchange is conducted via supersonic communications means.

10. The means of claim 1, wherein said data exchange is conducted via a temporary data cable.

11. The means of claim 1, wherein said communications means include low power radio transceiver equipment, with a communications range under 100 meters.

12. The means of claim 1, wherein said messaging nodes are geographically distributed in locations accessible to the public.

13. A method for the delivery of an incoming message in a messaging system comprising a plurality of messaging nodes, a plurality of user accounts with distinct messaging address identifiers, and a plurality of portable messaging units with firmware for controlling messaging operations, said method comprising the steps of:
a) transporting a portable messaging unit to the immediate proximity of a messaging node;
b) identifying at least one user account, associated with said portable messaging unit, to said messaging node;
c) delivering incoming messages for said user account from said messaging node to said portable messaging unit;
d) storing said incoming message within said portable messaging unit;
whereby incoming messages are delivered to said portable messaging unit with firmware for controlling messaging operations.

14. The method of claim 13, further comprising the step of verifying that said user account has sufficient credit to receive incoming messaging traffic before said incoming message is delivered to said portable messaging unit.

15. The method of claim 14, wherein said messaging system further comprises a central server, and the verification of said sufficient credit is performed by said central server.

16. The method of claim 13, further comprising the step of said messaging node proactively buffering incoming messages for said user account prior to the transport of said portable messaging unit to the immediate proximity of said messaging node.

17. The method of claim 13, further comprising the step of requesting incoming messages by said messaging node for said user account subsequent to the identification of said user account to said messaging node, for immediate delivery to said portable messaging unit.

18. The method of claim 13, wherein said messaging system further comprises a central server, and further comprising the step of requesting incoming messages for said user account by said messaging node from said central server.

19. The method of claim 13, further comprising the step of transferring mail server information, including a username and password for said mail server, from said portable messaging unit to said messaging node; and the step of retrieving said incoming messages from said mail server, prior to the delivery of said incoming messages to said portable messaging unit.

20. The means of claim 13, wherein said data exchange is conducted via photonic communications means.

21. The means of claim 13, wherein said data exchange is conducted via supersonic communications means.

22. The means of claim 13, wherein said data exchange is conducted via a temporary data cable.

23. The means of claim 13, wherein said communications means include low power radio transceiver equipment, with a communications range under 100 meters.

24. The method of claim 13, wherein said incoming message comprises a text message.

25. The method of claim 1, wherein said incoming message is an automated response to an outgoing message previously sent from said user account, where said outgoing message was a request for advanced network functions.

26. The method of claim 25, wherein said advanced network functions comprise network webpage retrieval.

27. A method for the delivery of an outgoing message in a messaging system comprising a plurality of messaging nodes, a plurality of user accounts with distinct messaging address identifiers, and a plurality of portable messaging units with firmware controlling messaging operations, said method comprising the steps of:
a) composing said outgoing message on a portable messaging unit;
b) storing said outgoing message within said portable messaging unit;
c) transporting said portable messaging unit to the immediate proximity of a messaging node;
d) delivering said outgoing message from said portable messaging unit to said messaging node,
e) storing said outgoing message within said messaging node;
f) relaying said outgoing message from said messaging node to a delivery address.
whereby outgoing messages are composed and sent from a portable messaging unit with firmware for controlling messaging operations.

28. The method of claim 27, wherein said messaging system further comprises a central server, and said method further comprises the step of said central server verifying that said user account has sufficient credit to send outgoing messaging traffic before said outgoing message is relayed by said messaging node.

29. The method of claim 27, wherein the delivery of said outgoing message from said portable messaging unit to said messaging node is conducted via photonic communications means.

30. The method of claim 27, wherein the delivery of said outgoing message from said portable messaging unit to said messaging node is conducted via supersonic communications means.

31. The method of claim 27, wherein the delivery of said outgoing message from said portable messaging unit to said messaging node is conducted via photonic communications means.

32. The method of claim 27, wherein the delivery of said outgoing message from said portable messaging unit to said messaging node is conducted via low power radio transceiver equipment, with a communications range under 100 meters.

33. The method of claim 27, wherein said outgoing message comprises a text message.

34. A method for the transfer of data between a portable messaging unit and a messaging node, where said messaging node
a) detects the presence of a portable messaging unit in an immediate proximity;
b) automatically enters a data exchange with said portable messaging unit;
c) identifies at least one user account associated with said portable messaging unit;
d) triggers the delivery of outgoing messages from said portable messaging node;
e) identifies incoming messages addressed to user accounts associated with said portable messaging unit;
f) delivers said incoming messages to said portable messaging unit,
within a messaging system comprising a plurality of messaging nodes and a plurality of portable messaging units with firmware for controlling messaging operations.
